(19) United States
(12) Patent Application Publication
(10) Pub. No.: US 2025/0371666 A1
(43) Pub. Date: Dec. 4, 2025

(54) IMAGE PROCESSING METHOD AND APPARATUS, TERMINAL AND STORAGE MEDIUM

(71) Applicant: Beijing Zitiao Network Technology Co., Ltd., Beijing (CN)

(72) Inventor: Shuai LIU, Beijing (CN)

(21) Appl. No.: 19/223,748

(22) Filed: May 30, 2025

(30) Foreign Application Priority Data
May 30, 2024 (CN) 202410693516.2

(51) Int. Cl. G06T 3/60; G06F 3/04815; G06T 1/00; G06T 5/50; G06T 7/62; G06T 7/70

(52) U.S. Cl. CPC G06T 3/60; G06F 3/04815; G06T 1/0007; G06T 5/50; G06T 7/62; G06T 7/70

(57) ABSTRACT

The present disclosure provides an image processing method and apparatus, electronic device, and storage medium. The image processing method includes: in response to a preset operation, determining a target object in a current operation interface; creating a first layer and a second layer; creating a virtual camera; by taking the position of the target object as an original point and taking a distance from the virtual camera to the original point as radius, rotationally adjusting the position of the virtual camera according to a preset angle, and acquiring the image of the target object at each adjustment position by means of the virtual camera; and rendering the background image to the first layer, and rendering the image of the target object to the second layer.

### CROSS-REFERENCE TO RELATED APPLICATION

This application claims priority to Chinese Patent Application No. 202410693516.2, filed on May 30, 2024, which is incorporated herein by reference in its entirety as a part of this application.

### TECHNICAL FIELD

The present disclosure relates to the technical field of information and particularly relates to an image processing method and apparatus, a terminal, and a storage medium.

### BACKGROUND

General screenshot-taking modes in a virtual reality (VR) device are only to take a screenshot of a certain frame of content as a picture, and this picture can only be browsed as an ordinary picture, and the common screenshot-taking steps are as shown in FIG. 1. Ordinary images often fail to attract users, and some modes of interacting with images will make the users more willing to share and interact with the images. The existing GIF can only play and save some images, and it takes up a lot of disk space. Therefore, it is expected to further improve in this aspect.

### SUMMARY

In order to solve the existing problems, the present disclosure provides an image processing method and device, a terminal, and a storage medium.

The present disclosure adopts the following technical scheme.

An embodiment of the present disclosure provides an image processing method, which includes: in response to a preset operation, determining a target object in a current operation interface; creating a first layer and a second layer, wherein the first layer is used for receiving a background image except for the target object in the current operation interface, and the second layer is used for receiving an image of the target object; creating a virtual camera, wherein a position of the virtual camera is consistent with coordinates of an electronic device in a virtual world; by taking a position of the target object as an original point and taking a distance from the virtual camera to the original point as a radius, rotationally adjusting the position of the virtual camera according to a preset angle, and acquiring the image of the target object at each adjustment position through the virtual camera; and rendering the background image to the first layer, and rendering the image of the target object to the second layer.

Another embodiment of the present disclosure provides an image processing apparatus, which includes: a target object determination module, configured to: in response to a preset operation, determine a target object in a current operation interface; a layer creating module, configured to create a first layer and a second layer, wherein the first layer is used for receiving a background image except the target object in the current operation interface, and the second layer is used for receiving an image of the target object; a virtual camera creating module, configured to create a virtual camera, wherein the position of the virtual camera is consistent with coordinates of an electronic device in a virtual world; an image acquisition module, configured to: by taking the position of the target object as an original point and taking a distance from the virtual camera to the original point as radius, rotationally adjust the position of the virtual camera according to a preset angle, and acquire the image of the target object at each adjustment position by means of the virtual camera; and a rendering module, configured to render the background image to the first layer, and render the image of the target object to the second layer.

In some embodiments, a terminal is provided in the present disclosure, which includes: at least one memory and at least one processor, wherein the at least one memory is configured to store program codes, and the at least one processor is configured to call the program codes stored in the at least one memory to execute the image processing method described above.

In some embodiments, a storage medium is provided in the present disclosure, which is configured to store program codes, wherein the program codes are used for executing the image processing method described above.

### BRIEF DESCRIPTION OF DRAWINGS

The above and other features, advantages and aspects of embodiments of the present disclosure will become more apparent by referring to the following detailed description when taken in conjunction with the accompanying drawings. Throughout the drawings, the same or similar reference numerals indicate the same or similar elements. It should be understood that the drawings are schematic and elements and elements are not necessarily drawn to scale.

FIG. 1 is a schematic diagram of a screenshot taking process in the related art.

FIG. 2 is a flowchart of an image processing method according to an embodiment of the present disclosure.

FIG. 3 is a schematic diagram of coordinates of a target object according to an embodiment of the present disclosure.

FIG. 4 is a schematic diagram of storage of a screenshot file according to an embodiment of the present disclosure.

FIG. 5 is a schematic diagram of a coordinate system according to an embodiment of the present disclosure.

FIG. 6 is a schematic diagram of shooting a target object by a virtual camera according to an embodiment of the present disclosure.

FIG. 7 is a schematic diagram of shooting a target object by a virtual camera according to an embodiment of the present disclosure.

FIG. 8 is a schematic diagram of a screenshot-taking process according to an embodiment of the present disclosure.

FIG. 9 shows some modules of an image processing apparatus according to another embodiment of the present disclosure.

FIG. 10 is a structure schematic diagram of an electronic device according to an embodiment of the present disclosure.

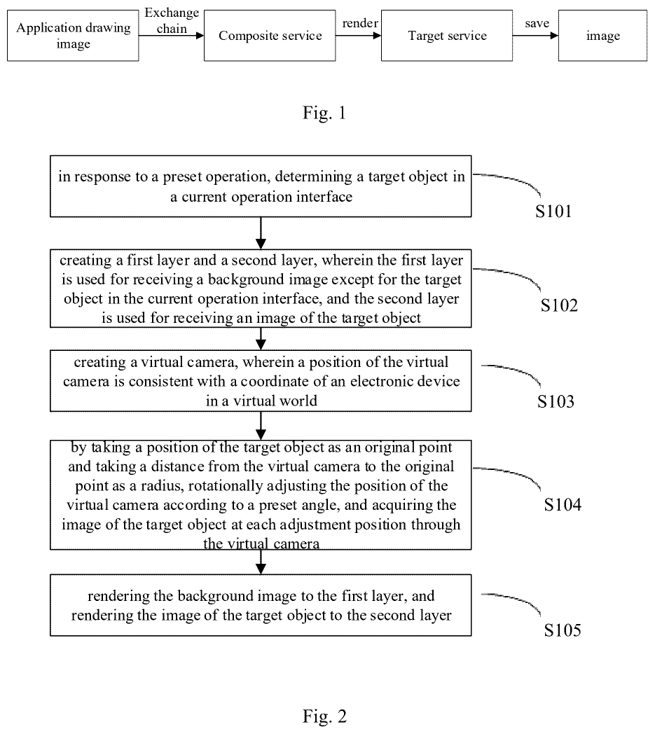

### DETAILED DESCRIPTION

Embodiments of the present disclosure will be described in more detail below with reference to the accompanying drawings. Although some embodiments of the present disclosure are shown in the drawings, it should be understood that the present disclosure can be embodied in various forms and should not be construed as limited to the embodiments set forth here, but rather, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that various steps described in the method embodiments of the present disclosure can be performed in parallel and/or in parallel. Furthermore, method embodiments may include additional steps and/or omit performing the illustrated steps. The scope of the present disclosure is not limited in this respect.

As used herein, the term “including” and its variants are open-ended including, that is, “including but not limited to”. The term “based on” is “at least partially based on”. The term “one embodiment” means “at least one embodiment”; The term “another embodiment” means “at least one other embodiment”; the term “some embodiments” means “at least some embodiments”. Related definitions of other terms will be given in the following description.

It should be noted that the concepts of “first” and “second” mentioned in this disclosure are only used to distinguish different devices, modules or units, and are not used to limit the order or interdependence of the functions performed by these devices, modules or units.

It should be noted that the modification of “a” mentioned in this disclosure is schematic rather than limiting, and those skilled in the art should understand that it should be understood as “one or more” unless the context clearly indicates otherwise.

Names of messages or information exchanged among multiple devices in the embodiment of the present disclosure are only used for illustrative purposes, and are not used to limit the scope of these messages or information.

According to an image processing method in the present disclosure, it is allowed to perform screenshot taking in a VR (Virtual Reality) device, saved pictures can be used for interacting with a user, the user can adjust the position and angle of part of contents, or display dynamic pictures, and a small disk space is taken up.

FIG. 2 is a flowchart of an image processing method according to an embodiment of the present disclosure. The image processing method according to the present disclosure may include a step S101: in response to a preset operation, determining a target object in a current operation interface. In some embodiments, the image processing method according to the present disclosure is applied to the VR device, such as a headset, for example, virtual reality glasses. In some embodiments, the preset operation includes a screenshot-taking operation. In some embodiments, the current operation interface includes an interface selected by the preset operation, for example, a screenshot picture or a screenshot region. In some embodiments, the target object includes an object expected to interact with the user. In some embodiments, in response to that the electronic device runs a certain VR application and needs to take a screenshot, composite service will firstly notify the application that it is in an interactive screenshot-taking mode at present, and the application can mark the interactive target object.

In some embodiments, the method according to the present disclosure may further include a step S102: creating a first layer and a second layer, where the first layer is used for receiving a background image except the target object in the current operation interface, and the second layer is used for receiving an image of the target object. For example, in response to that the target object is assumed to be a sphere, the background image is an image except the sphere in a screenshot image.

In some embodiments, the method according to the present disclosure may further include a step S103: creating a virtual camera, where the position of the virtual camera is consistent with coordinates of an electronic device in a virtual world. As described above, the electronic device may include a VR headset. In some embodiments, the virtual camera is configured to acquire images of the target object at different angles.

In some embodiments, the method according to the present disclosure may further include a step S104: by taking the position of the target object as an original point and taking a distance from the virtual camera to the original point as a radius, rotationally adjusting the position of the virtual camera according to a preset angle, and acquiring the image of the target object at each adjustment position through the virtual camera. In some embodiments, the preset angle is associated with the number of expected images of the target object. For example, in response to that 24 frames of images of the target object are expected to be acquired, corresponding to 360° of the circumference, the preset angle is 15°, namely, one frame of image of the target object may be acquired every time the position is rotationally adjusted by 15°. For example, in response to that 12 frames of images of the target object are expected to be acquired, the preset angle is 30° corresponding to 360° of the circumference.

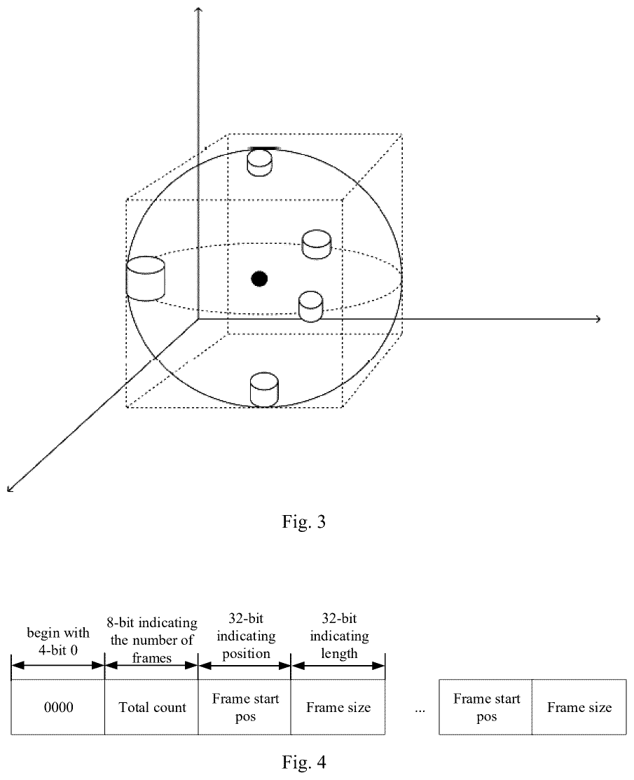

In some embodiments, the position of the target object is a position where a sphere center of an inscribed sphere of a bounding box of the target object is located. As shown in FIG. 3, the target object may include a plurality of objects, and the sphere center (a black point in the sphere center in FIG. 3) of the inscribed sphere of the bounding box (e.g., cuboid) of the target object is treated as a coordinate of the target object. In some embodiments, the rotationally adjusting the position of the virtual camera according to the preset angle includes: rotationally adjusting the position of the virtual camera clockwise according to the preset angle. In some embodiments, the acquiring the image of the target object at each adjustment position by means of the virtual camera includes: acquiring the image of the target object at each adjustment position under a condition that the virtual camera faces the sphere center.

In some embodiments, the method according to the present disclosure may further include a step S105: rendering the background image to the first layer, and rendering the image of the target object to the second layer. In some embodiments, after the composite service receives the layer submitted by the application, the first layer without the target object may be rendered first, and then the second layer containing only the target object may be rendered. By rendering the background image and the target object to different layers, the background image and the corresponding image frame of the target object may be superposed based on the interaction operation in the process of the user interacting with the screenshot file, thereby displaying the superposition image to produce an interaction effect.

According to the present disclosure, a picture, which is allowed to interact with users, may be taken with screenshot in the electronic device (such as the VR device), thus, the users can carry out some simple interactions, such as rotation and dragging, according to an interactive region set by an application, and a small disk space is taken up.

In some embodiments, the image processing method according to the present disclosure further includes: compressing the first layer in a first format; and compressing a second layer in a second format, where the first format is different from the second format. In some embodiments, the first format is a compression mode without a transparent layer, and the second format is a compression mode with a transparent layer, and thus the first image layer and the second image layer may be displayed in a superposing mode. In some embodiments, the first format only has an RGB channel for reducing the size of the file, and the second format has an RGBA channel, namely, the second format has an alpha (transparent) channel, and the first format does not has the alpha (transparent) channel. In some embodiments, the first format is a jpeg format, and the second format is a png format.

In some embodiments, the image processing method according to the present disclosure further includes: writing the compressed first layer and second layer into the screenshot file. In some embodiments, in response to writing the screenshot file, the content of the first layer is written firstly, then the first frame of image, acquired in the state of the preset operation state, of the target object is written, where the first frame of image is the first one of images acquired by the virtual camera at a plurality of adjustment positions; after one image frame of the target object is written each time, the size of the frame of image and the position thereof in the file may be recorded; finally, the position of each image frame of the target object in the file is placed in a file header; and the file header is saved in a fixed length and format. As shown in FIG. 4, 4 bits of 0 are treated as the beginning, 8 bits are the total frame number, and the later 64 bits are the starting position and length of each frame.

In some embodiments, the image processing method according to the present disclosure further includes: in response to an operation of viewing the screenshot file, displaying a superimposed image obtained by superimposing the background image and a first frame of image of the target object acquired in a state of the preset operation, where the first frame of image is a first one of images acquired by the virtual camera at a plurality of adjustment positions. In some embodiments, when the user views a picture, the background image without the target object and the first frame of image of the target object are displayed firstly, and the user can rotate the target object or the interactive object left and right, or drag the target object to display at different positions. For example, in response to that the user views the screenshot image, the final index position is loaded firstly, the image shows the superimposed image of the background image and the first frame of image, namely, the image is completely consistent with the image during screenshot taking by the user; and in response to that the user wants to interact with some target objects, according to the operation of the user, for example, dragging the target object with a finger to rotate, and according to the moving direction and distance of the finger, it is dynamically switched to a superimposed picture obtained by superimposing the corresponding image of the target object and the background image. For example, the corresponding image is an image determined by the direction and distance of the interaction operation among a plurality of images obtained by the virtual camera at the plurality of adjustment positions. For example, the target object is the earth, and the user can drag the earth to rotate during interaction.

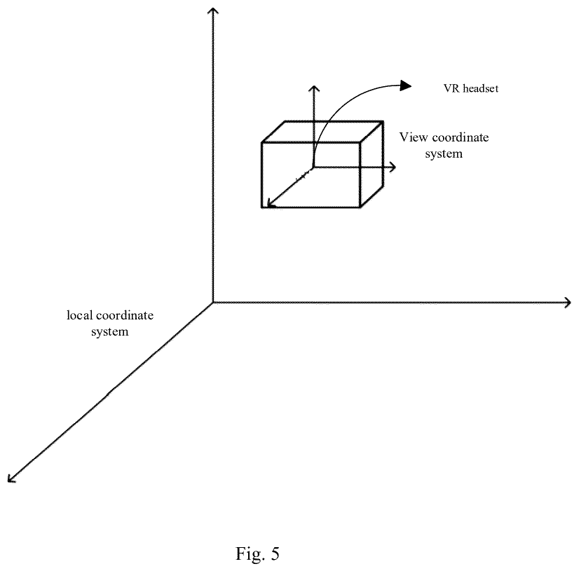

In some embodiments, in response to that each application is started, there is a local coordinate system which is marked as a Local coordinate system, and the VR headset may have a viewpoint coordinate system which is marked as a View coordinate system; and in the VR world, each object has a coordinate, and the coordinate may be based on the Local coordinate or the View coordinate, as shown in FIG. 5.

As described above, in response to that the application receives a screenshot-taking notification, a virtual camera may be created, and the position of the virtual camera is consistent with the coordinates of the electronic device (such as the VR device) in the virtual world. Moreover, the application can mark which content in a current scenario is the target object or the interactive object, and the virtual camera only shoots the target object. The position of the target object is transformed into the coordinates in the view coordinate system, the target object may include a plurality of objects, and at the moment, it is needed to compute the sphere center of the inscribed sphere of a maximum bounding box as the coordinates of the target object. As shown in FIG. 3, the maximum distance of all the distances in the bounding box is determined, then a maximum inscribed sphere is determined according to the maximum distance, and the sphere center of the sphere serves as the coordinates of the target object

The coordinates of the target object are transformed into values in the view coordinate system; it is assumed that the coordinates of the sphere center of the Local coordinate system are (x1, y1, z1), and the coordinates of the headset in the local coordinate system are (x2, y2, z2), the coordinates are to be (x1-x2, y1-y2, z1-z2) after transforming into the view coordinate system, then the coordinates are taken as a negative number, thus the coordinates of the current headset relative to the sphere center are acquired, and the virtual camera is created at the coordinate position.

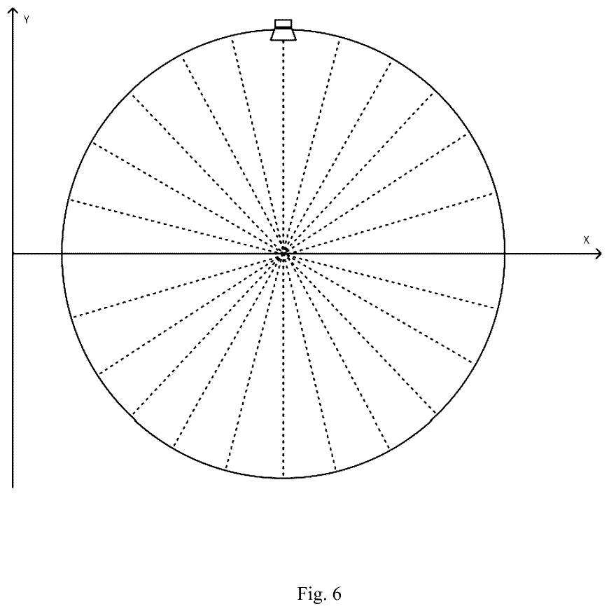

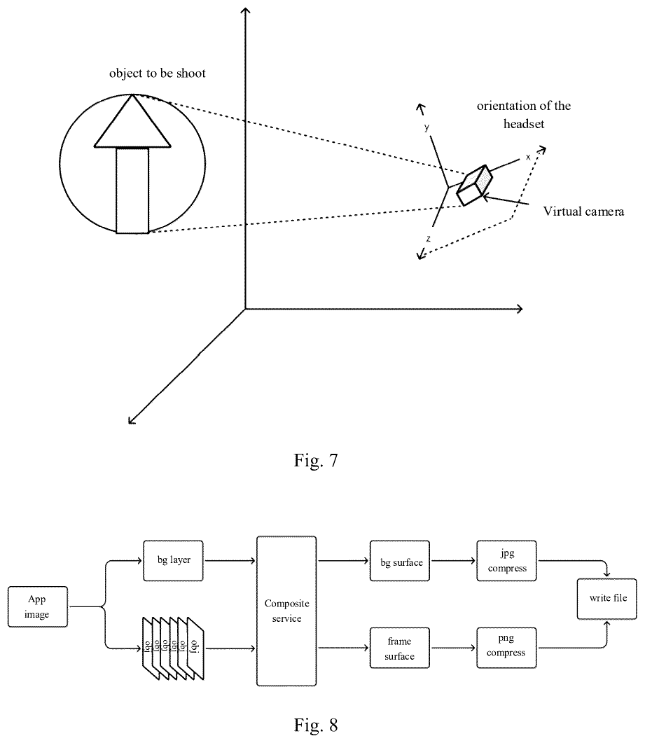

In response to determine the position of the virtual camera shooting the target object, the coordinates (coordinates of the sphere center) of the target object are treated as an original point, and the position of the virtual camera is modified in each of the following 24 frames (it is assumed that 24 frames of images of the target object are acquired). For example, because the content of the following 24 frames is collected in the embodiment, by taking the sphere center as the original point and the distance from the headset to the sphere center as the radius, every time the position of the virtual camera is adjusted clockwise to rotate by 15°, the virtual camera is horizontal and does not move up and down. At the moment of screenshot taking, the computed position of the virtual camera is as shown in FIG. 6, which is relative to the sphere center coordinate system, (x, y, z), and the orientation is −90°, and on an xy plane, and the next coordinates are x′=r *sin(Π/24)+x, y′=r*cos(Π/24)+y, z′=z. The coordinates relative to the View coordinate system may be computed by taking the negative, then the coordinates based on the local coordinate system are computed, the coordinates of the headset in the local coordinate system are (x2, y2, z2), and the computed coordinates of the virtual camera are (x′+x2, y′+y2, z′+z2). After the coordinate position of the virtual camera and the position of the target object are determined, the image, shot by the virtual camera at the corresponding position, of the target object can be acquired. In some embodiments, the virtual camera faces or is aligned with the sphere center, as shown in FIG. 7; and in addition, it is rotated in parallel to an X-Z plane in the position-adjusting process.

As shown in FIG. 8, it is a schematic diagram of a screenshot-taking process according to an embodiment of the present disclosure; in response to that screenshot taking is performed, two layers (the first layer and the second layer) are created as rendering carriers, the first layer is treated as a background content (bg layer) except the target object, and the second layer is treated as an image (obj) for saving each frame of the target object. The composite service renders the bg layer to the first layer (namely, bg surface) respectively, renders the obj layer to the second layer (namely, frame surface) at the same time, and then writes the content into the screenshot file after carrying out jpeg compression on the bg layer and carrying out png compression on the frame layer respectively.

With the screenshot-taking method according to the present disclosure, a better interaction mode can be provided, and a user generation content (ugc) can be better generated. The generated screenshot file can be in interaction with the user, for example, the target object can be rotated and dragged, and the screenshot file takes up much smaller space than existing motion graphics gif.

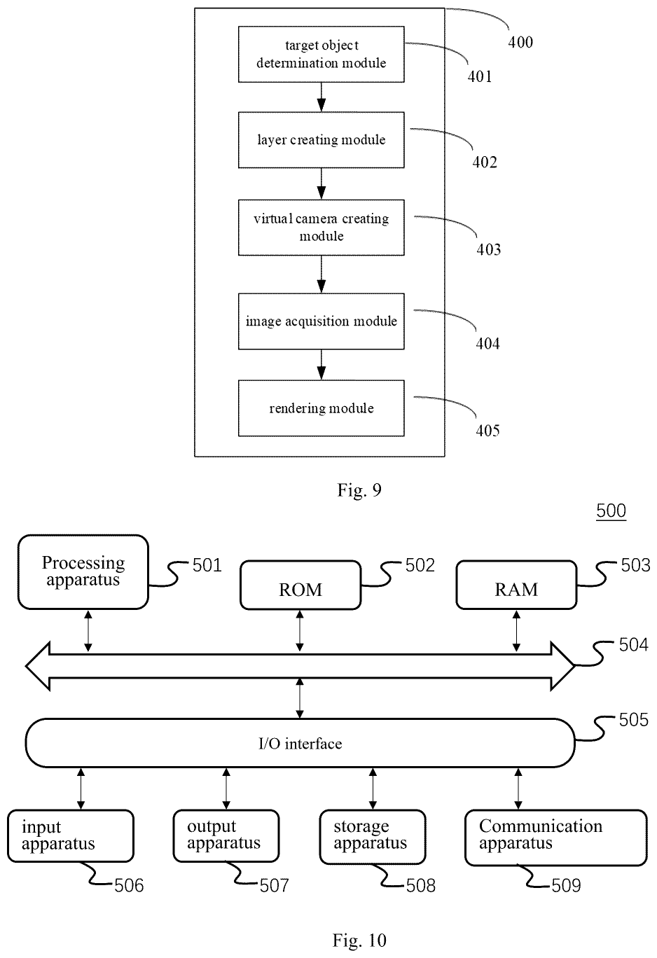

An embodiment of the present disclosure further provides an image processing apparatus 400. FIG. 9 shows an image processing apparatus 400 according to some embodiments. The image processing apparatus 400 includes a target object determination module 401, a layer creating module 402, a virtual camera creating module 403, an image acquisition module 404, and a rendering module 405. In some embodiments, the target object determination module 401 is configured to: in response to a preset operation, determine a target object in a current operation interface. In some embodiments, the layer creating module 402 is configured to create a first layer and a second layer, in which, the first layer is used for receiving a background image except the target object in the current operation interface, and the second layer is used for receiving an image of the target object. In some embodiments, the virtual camera creating module 403 is configured to create a virtual camera, and the position of the virtual camera is consistent with coordinates of an electronic device in a virtual world. In some embodiments, the image acquisition module 404 is configured to: by taking the position of the target object as an original point and taking a distance from the virtual camera to the original point as radius, rotationally adjust the position of the virtual camera according to a preset angle, and acquire the image of the target object at each adjustment position by means of the virtual camera. In some embodiments, the rendering module 405 is configured to render the background image to the first layer, and render the image of the target object to the second layer.

It is to be understood that the content described about the image processing method also applies to the image processing apparatus 400 here, and for the sake of simplicity, it will not be described in detail here.

In some embodiments, the preset operation includes a screenshot-taking operation. In some embodiments, the preset angle is associated with the number of expected images of the target object. In some embodiments, the position of the target object is a position where a sphere center of an inscribed sphere of a bounding box of the target object is located; the rotationally adjusting the position of the virtual camera according to the preset angle includes: rotationally adjusting the position of the virtual camera clockwise according to the preset angle; and the acquiring the image of the target object at each adjustment position by means of the virtual camera includes: acquiring the image of the target object at each adjustment position under a condition that the virtual camera faces the sphere center. In some embodiments, the image processing apparatus further includes: a compression module which is configured to compress the first layer in a first format; and compress a second layer in a second format, in which, the first format is different from the second format. In some embodiments, the first format is a jpeg format, and the second format is a png format. In some embodiments, the image processing apparatus further includes: a storage module which is configured to write the compressed first layer and compressed second layer in a screenshot file. In some embodiments, the image processing apparatus further includes: a display module that is configured to: in response to an operation of viewing the screenshot file, display a superimposed image obtained by superimposing the background image and a first frame of image of the target object acquired in a state of the preset operation, where the first frame of image is a first one of images acquired by the virtual camera at a plurality of adjustment positions; in response to an interaction operation for the target object, based on a direction and a distance of the interaction operation, display a superimposed image by superimposing the background image and a corresponding image of the target object.

In addition, the present disclosure further provides an electronic device, which includes: at least one memory and at least one processor, in which, the memory is configured to store program codes, and the processor is configured to call the program codes stored in the memory to execute the image processing method.

In addition, the present disclosure further provides a computer-readable storage medium that stores program codes, and the program codes are used for executing the image processing method.

As described above, the image processing method and apparatus according to the present disclosure are illustrated based on the embodiments and the examples. In addition, the present disclosure further provides the electronic device and the storage medium which are described below.

With reference to FIG. 10, it is a structure schematic diagram of an electronic device (such as a terminal device or a server) 500 suitable for implementing the embodiment of the present disclosure. The terminal device in the embodiment of the present disclosure can include but is not limited to mobile terminals such as a mobile phone, a notebook computer, a digital broadcast receiver, a PDA (personal digital assistant), a PAD (tablet personal computer), a PMP (portable multimedia player), and a vehicle-mounted terminal (such as a vehicle-mounted navigation terminal), and immobile terminals such as a digital TV, a desktop computer. The electronic device shown in FIG. 5 is only an example and does not bring any limitation to the functions and the use range of the embodiment of the present disclosure.

As shown in FIG. 10, the electronic device 500 may include a processing apparatus (such as a central processor, and a graphic processor) 501, which can perform various appropriate actions and processing according to a program stored in a read-only memory (ROM) 502 or a program loaded from a storage apparatus 508 to a Random Access Memory (RAM) 503. In the RAM 503, various programs and data required for the operation of the electronic device 500 are also stored. The processing apparatus 501, ROM 502, and RAM 503 are connected to one another through a bus 504. An input/output (I/O) interface 505 is also connected to the bus 504.

Generally, the following apparatuses can be connected to the I/O interface 505: an input apparatus 506 including, for example, a touch screen, a touch-pad, a keyboard, a mouse, a camera, a microphone, an accelerometer, and a gyroscope, an output apparatus 507 including, for example, a Liquid Crystal Display (LCD), a loudspeaker, and a vibrator, a storage apparatus 508 including, for example, a magnetic tape, and a hard disk, and a communication apparatus 509. The communication apparatus 509 can allow the electronic device 500 to perform wireless or wired communication with other electronic devices to exchange data. Although the electronic device 500 with various apparatuses is shown in FIG. 10, it is to be understood that it is not needed to implement or provided with all the shown apparatuses. It can be alternatively implemented or provided with more or less apparatuses.

Particularly, according to the embodiment of the present disclosure, the process described with reference to the flowchart can be implemented as a computer software program. For example, an embodiment of the present disclosure includes a computer program product which includes a computer program carried on a computer-readable medium, and the computer program contains program codes for executing the method in the flowchart. In such embodiment, the computer program can be downloaded and installed from a network through the communication apparatus 509, or installed from the storage apparatus 508, or installed from the ROM 502. In response to that the computer program is executed by the processing apparatus 501, functions defined in the method according to the embodiment of the present disclosure can be realized.

It is to be noted that the computer-readable medium described above of the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus or instrument, or any combination thereof. More specific examples of the computer-readable storage media may be include, but not limited to, an electrical connector, a portable computer disk, a hard disk, a Random Access Memory (RAM), a Read Only Memory (ROM), an erasable programmable read-only memory (EPROM or flash memory), an optical fiber, a portable compact disk read-only memory (CD-ROM), an optical storage device, a magnetic storage device, or any suitable combination thereof having one or more wires. In the present disclosure, the computer-readable storage medium may be any tangible medium containing or storing a program that may be used by or in combination with an instruction execution system, apparatus or instrument. In the present disclosure, the computer-readable signal medium may include a data signal that propagates in a baseband or as part of a carrier, in which, the computer-readable program code is carried. Such propagated data signal may take a variety of forms, including, but not limited to, an electromagnetic signal, an optical signal, or any suitable combination thereof. The computer-readable signal medium may also be any computer-readable medium other than the computer-readable storage medium that may transmit, propagate, or transmit a program for use by or in combination with the instruction execution system, apparatus or instrument. The program code contained on the computer-readable medium may be transmitted with any suitable medium, including, but not limited to, an electrical wire, an optical cable, an RF (radio frequency), or any suitable combination thereof.

In some embodiments, a client and the server may communicate using any currently known or future developed network protocol, such as HTTP (HyperText Transfer Protocol), and may interconnect with digital data communications (e.g., communications networks) of any form or medium. Examples of the communications networks include local area networks (“LANs”), wide area networks (“WANs”), Internet networks (e.g., Internet) and end-to-end networks (e.g., ad hoc end-to-end networks), and any currently known or future developed networks.

The computer-readable medium may be contained in the electronic device described above, or may be present alone, without being assembled into the electronic device.

The computer-readable medium carries one or more programs, and in response to that the one or more programs are executed by the electronic device, the electronic device is configured to execute the method according to the present disclosure.

The computer program code for executing the operations of the present disclosure may be written in one or more programming languages or a combination thereof, including, but not limited to, object-oriented programming languages, such as Java, Smalltalk, C++, and conventional procedural programming languages, such as “C” or similar programming languages. The program code can be executed entirely on a user computer, partially on the user computer, as a separate software package, partially on the user computer and partially on a remote computer, or entirely on the remote computer or server. In response to involve the remote computer, the remote computer may be connected to the user computer through any type of network, including the local area network (LAN) or the wide area network (WAN), or, may be connected to an external computer (e.g., via Internet service provider using Internet).

The flowchart and block diagram in the accompanying drawings illustrate the architecture, functions and operations that may be implemented by systems, methods and computer program products according to the various embodiments of the present disclosure. In this regard, each block in the flowchart or block diagram may represent a module, program segment, or part of code, and the module, program segment, or part of code contains one or more executable instructions for implementing a prescribed logical function. It is also to be noted that in some embodiments as an alternative, the functions marked in the blocks may also occur in a different order than in the accompanying drawings. For example, two blocks represented in succession may actually be executed substantially in parallel, and sometimes in an opposite order, depending on the function involved. It is also to be noted that each block in the block diagram and/or flowchart, and the combination of blocks in the block diagram and/or flowchart, may be implemented in a dedicated hardware-based system that executes the prescribed function or operation, or may be implemented in a combination of dedicated hardware and computer instructions.

The units described in the embodiments of the present disclosure can be implemented either in software, or in hardware. The names of the units do not form a limitation to the unit itself in some cases.

The functions described above can be performed at least in part by one or more hardware logic components. For example, non-limiting, exemplary types of hardware logic components that can be used include: Field Programmable Gate Arrays (FPGAs), Application Specific Integrated Circuits (ASICs), Application Specific Standard Products (ASSPs), system-on-chips (SOCs), Complex Programmable Logic Devices (CPLDs), etc.

In the context of the present disclosure, the machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, the electronic, magnetic, optical, electromagnetic, infrared, or semiconductor system, apparatus, or device, or any suitable combination of the foregoing. A more specific example of the machine-readable storage medium may include an electrical connector based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

At least one embodiment of the present disclose, provides an image processing method, the image processing method includes: in response to a preset operation, determining a target object in a current operation interface; creating a first layer and a second layer, wherein the first layer is used for receiving a background image except for the target object in the current operation interface, and the second layer is used for receiving an image of the target object; creating a virtual camera, wherein a position of the virtual camera is consistent with coordinates of an electronic device in a virtual world; by taking a position of the target object as an original point and taking a distance from the virtual camera to the original point as a radius, rotationally adjusting the position of the virtual camera according to a preset angle, and acquiring the image of the target object at each adjustment position through the virtual camera; and rendering the background image to the first layer, and rendering the image of the target object to the second layer.

According to one or more embodiments of the present disclosure, the preset operation includes a screenshot-taking operation.

According to one or more embodiments of the present disclosure, the preset angle is associated with a total number of images of the target object that is expected to acquire.

According to one or more embodiments of the present disclosure, the position of the target object is a position where a sphere center of an inscribed sphere of a bounding box of the target object is located; the rotationally adjusting the position of the virtual camera according to a preset angle, includes: rotationally adjusting the position of the virtual camera clockwise according to the preset angle; and the acquiring the image of the target object at each adjustment position through the virtual camera, includes: acquiring the image of the target object at each adjustment position under a condition that the virtual camera faces the sphere center.

According to one or more embodiments of the present disclosure, the image processing method further includes: compressing the first layer in a first format; and compressing the second layer in a second format, wherein the first format is different from the second format.

According to one or more embodiments of the present disclosure, the first format has an RGB channel, and the second format has an RGBA channel.

According to one or more embodiments of the present disclosure, the image processing method further includes: writing a compressed first layer and a compressed second layer into a screenshot file.

According to one or more embodiments of the present disclosure, the image processing method further includes: in response to an operation of viewing the screenshot file, displaying a superimposed image obtained by superimposing the background image and a first frame of image of the target object acquired in a state of the preset operation, wherein the first frame of image is a first one of images acquired by the virtual camera at a plurality of adjustment positions; and in response to an interaction operation for the target object, based on a direction and a distance of the interaction operation, displaying a superimposed image by superimposing the background image and a corresponding image of the target object.

According to one or more embodiments, provides an image processing apparatus, the image processing apparatus includes: a target object determination module, configured to: in response to a preset operation, determine a target object in a current operation interface; a layer creating module, configured to create a first layer and a second layer, wherein the first layer is used for receiving a background image except the target object in the current operation interface, and the second layer is used for receiving an image of the target object; a virtual camera creating module, configured to create a virtual camera, wherein the position of the virtual camera is consistent with coordinates of an electronic device in a virtual world; an image acquisition module, configured to: by taking the position of the target object as an original point and taking a distance from the virtual camera to the original point as radius, rotationally adjust the position of the virtual camera according to a preset angle, and acquire the image of the target object at each adjustment position by means of the virtual camera; and a rendering module, configured to render the background image to the first layer, and render the image of the target object to the second layer.

According to one or more embodiments, provides an electronic device, which includes: at least one memory and at least one processor, wherein the at least one memory is configured to store program codes, and the at least one processor is configured to call the program codes stored in the at least one memory to execute the image processing method described above.

According to one or more embodiments, provides a non-transitory computer-readable storage medium, configured to store program codes, where the program codes are used for executing the image processing method described above.

The above description is only the preferred embodiment of the present disclosure and the explanation of the applied technical principles. It should be understood by those skilled in the art that the disclosure scope involved in this disclosure is not limited to the technical scheme formed by the specific combination of the above technical features, but also covers other technical schemes formed by any combination of the above technical features or their equivalent features without departing from the above disclosure concept. For example, the above features are replaced with (but not limited to) technical features with similar functions disclosed in this disclosure.

Furthermore, although the operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological logical acts, it should be understood that the subject matter defined in the appended claims is not necessarily limited to the specific features or acts described above. On the contrary, the specific features and actions described above are only exemplary forms of implementing the claims.

1. An image processing method, comprising:
in response to a preset operation, determining a target object in a current operation interface;
creating a first layer and a second layer, wherein the first layer is used for receiving a background image except for the target object in the current operation interface, and the second layer is used for receiving an image of the target object;
creating a virtual camera, wherein a position of the virtual camera is consistent with coordinates of an electronic device in a virtual world;
by taking a position of the target object as an original point and taking a distance from the virtual camera to the original point as a radius, rotationally adjusting the position of the virtual camera according to a preset angle, and acquiring the image of the target object at each adjustment position through the virtual camera; and
rendering the background image to the first layer, and rendering the image of the target object to the second layer.

2. The image processing method according to claim 1, wherein the preset operation comprises a screenshot-taking operation.

3. The image processing method according to claim 1, wherein the preset angle is associated with a total number of images of the target object that is expected to acquire.

4. The image processing method according to claim 1, wherein the position of the target object is a position where a sphere center of an inscribed sphere of a bounding box of the target object is located;
the rotationally adjusting the position of the virtual camera according to a preset angle, comprises: rotationally adjusting the position of the virtual camera clockwise according to the preset angle; and
the acquiring the image of the target object at each adjustment position through the virtual camera, comprises: acquiring the image of the target object at each adjustment position under a condition that the virtual camera faces the sphere center.

5. The image processing method according to claim 1, further comprising:
compressing the first layer in a first format; and
compressing the second layer in a second format, wherein the first format is different from the second format.

6. The image processing method according to claim 5, wherein the first format has an RGB channel, and the second format has an RGBA channel.

7. The image processing method according to claim 4, further comprising:
writing a compressed first layer and a compressed second layer into a screenshot file.

8. The image processing method according to claim 7, further comprising:
in response to an operation of viewing the screenshot file, displaying a superimposed image obtained by superimposing the background image and a first frame of image of the target object acquired in a state of the preset operation, wherein the first frame of image is a first one of images acquired by the virtual camera at a plurality of adjustment positions; and
in response to an interaction operation for the target object, based on a direction and a distance of the interaction operation, displaying a superimposed image by superimposing the background image and a corresponding image of the target object.

9. An electronic device, comprising:
at least one memory and at least one processor, wherein
the at least one memory is configured to store program codes, and the at least one processor is configured to call the program codes stored in the at least one memory to execute an image processing method;
wherein the image processing method comprises:
in response to a preset operation, determining a target object in a current operation interface;
creating a first layer and a second layer, wherein the first layer is used for receiving a background image except for the target object in the current operation interface, and the second layer is used for receiving an image of the target object;
creating a virtual camera, wherein a position of the virtual camera is consistent with coordinates of an electronic device in a virtual world;
by taking a position of the target object as an original point and taking a distance from the virtual camera to the original point as a radius, rotationally adjusting the position of the virtual camera according to a preset angle, and acquiring the image of the target object at each adjustment position through the virtual camera; and
rendering the background image to the first layer, and rendering the image of the target object to the second layer.

10. The electronic device according to claim 9, wherein the preset operation comprises a screenshot-taking operation.

11. The electronic device according to claim 9, wherein the preset angle is associated with a total number of images of the target object that is expected to acquire.

12. The electronic device according to claim 9, wherein the position of the target object is a position where a sphere center of an inscribed sphere of a bounding box of the target object is located;
the rotationally adjusting the position of the virtual camera according to a preset angle, comprises: rotationally adjusting the position of the virtual camera clockwise according to the preset angle; and
the acquiring the image of the target object at each adjustment position through the virtual camera, comprises: acquiring the image of the target object at each adjustment position under a condition that the virtual camera faces the sphere center.

13. The electronic device according to claim 9, wherein the at least one processor is further configured to:
compress the first layer in a first format; and
compress the second layer in a second format, wherein the first format is different from the second format.

14. The electronic device according to claim 13, wherein the first format has an RGB channel, and the second format has an RGBA channel.

15. The electronic device according to claim 12, wherein the at least one processor is further configured to:
write a compressed first layer and a compressed second layer into a screenshot file.

16. The electronic device according to claim 15, wherein the at least one processor is further configured to:
in response to an operation of viewing the screenshot file, display a superimposed image obtained by superimposing the background image and a first frame of image of the target object acquired in a state of the preset operation, wherein the first frame of image is a first one of images acquired by the virtual camera at a plurality of adjustment position; and
in response to an interaction operation for the target object, based on a direction and a distance of the interaction operation, display a superimposed image by superimposing the background image and a corresponding image of the target object.

17. A non-transitory computer-readable storage medium, configured to store program codes, wherein the program codes are used for executing an image processing method;
wherein the image processing method comprises:
in response to a preset operation, determining a target object in a current operation interface;
creating a first layer and a second layer, wherein the first layer is used for receiving a background image except for the target object in the current operation interface, and the second layer is used for receiving an image of the target object;
creating a virtual camera, wherein a position of the virtual camera is consistent with coordinates of an electronic device in a virtual world;
by taking a position of the target object as an original point and taking a distance from the virtual camera to the original point as a radius, rotationally adjusting the position of the virtual camera according to a preset angle, and acquiring the image of the target object at each adjustment position through the virtual camera; and
rendering the background image to the first layer, and rendering the image of the target object to the second layer.

18. The non-transitory computer-readable storage medium according to claim 17, wherein the preset operation comprises a screenshot-taking operation.

19. The non-transitory computer-readable storage medium according to claim 17, wherein the preset angle is associated with a total number of images of the target object that is expected to acquire.

20. The non-transitory computer-readable storage medium according to claim 17, wherein the position of the target object is a position where a sphere center of an inscribed sphere of a bounding box of the target object is located;
the rotationally adjusting the position of the virtual camera according to a preset angle, comprises: rotationally adjusting the position of the virtual camera clockwise according to the preset angle; and
the acquiring the image of the target object at each adjustment position through the virtual camera, comprises: acquiring the image of the target object at each adjustment position under a condition that the virtual camera faces the sphere center.
